(19) United States
(12) Patent Application Publication
(10) Pub. No.: US 2025/0364186 A1
(43) Pub. Date: Nov. 27, 2025

(54) MULTILAYER CERAMIC CAPACITOR

(71) Applicant: Murata Manufacturing Co., Ltd., Nagaokakyo-shi, Kyoto-fu (JP)

(72) Inventors: Kenji UENO, Nagaokakyo-shi (JP); Kosuke URATANI, Nagaokakyo-shi (JP); Shinya ISOTA, Nagaokakyo-shi (JP); Hiroyuki WADA, Nagaokakyo-shi (JP); Hiroshi ASANO, Nagaokakyo-shi (JP)

(21) Appl. No.: 19/295,836

(22) Filed: Aug. 11, 2025

Related U.S. Application Data
(63) Continuation of application No. PCT/JP2024/030406, filed on Aug. 27, 2024.

(30) Foreign Application Priority Data
Aug. 28, 2023 (JP) 2023-137934

(51) Int. Cl. H01G 4/30; H01G 4/12

(52) U.S. Cl. CPC H01G 4/30; H01G 4/1227

(57) ABSTRACT

A multilayer ceramic capacitor includes an inner-layer portion, first and second outer-layer portions, and first and second side margin portions, and outer electrodes on the first and second end surfaces. Each of ceramic dielectrics of the inner-layer portion, the first and second outer-layer portions, and the first and second side margin portions includes multiple dielectric particles with a void therein. An intragranular void density in the ceramic dielectric in the inner-layer portion (Nᵢₙₙₑᵣ), intragranular void densities in the ceramic dielectrics in the first outer-layer portion and the second outer-layer portion (Nₒᵤₜₑᵣ), and intragranular void densities in the ceramic dielectrics in the first side margin portion and the second side margin portion (N_{side}) satisfy Nₒᵤₜₑᵣ<Nᵢₙₙₑᵣ and N_{side}<Nᵢₙₙₑᵣ.

### CROSS REFERENCE TO RELATED APPLICATIONS

This application claims the benefit of priority to Japanese Patent Application No. 2023-137934 filed on Aug. 28, 2023 and is a Continuation Application of PCT Application No. PCT/JP2024/030406 filed on Aug. 27, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

As electronic devices, typically mobile phones, become smaller and CPUs become faster, the need for multilayer ceramic capacitors (MLCCs) has been increasingly growing. A multilayer ceramic capacitor includes dielectric layers with a high dielectric constant formed as thin layers. A multilayer ceramic capacitor, therefore, has a large electrostatic capacitance despite being compact. Multilayer ceramic capacitors made with various materials are known, but ones made using ceramic dielectrics, such as barium titanate (BaTiO₃), in the dielectric layers and non-precious metals, such as nickel (Ni), in inner electrode layers are commonly used because they are inexpensive and have high characteristics.

A multilayer ceramic capacitor includes an inner-layer portion, in which dielectric layers formed of a ceramic dielectric and inner electrode layers are alternately stacked, outer-layer portions, which cover the top and bottom of the inner-layer portion, and side margin portions, which cover the inner-layer portion and the outer-layer portions in the width direction. The inner-layer portion defines and functions as a capacitive element. The outer-layer portions and the side margin portions are regions including no inner electrode layer that are provided around the inner-layer portion. These portions can be regarded as acting to protect the inner-layer portion, which defines and functions as a capacitive element, from the external environment.

Ceramic dielectrics used in multilayer ceramic capacitors are produced by sintering dielectric powders, such as BaTiO₃ powders. The dielectric powders are synthesized using a method such as the solid-phase method, the hydrothermal method, the sol-gel method, the alkoxide hydrolysis method, the solvothermal method, or the oxalate method. Of these, the hydrothermal method (hydrothermal synthesis) is a method in which a high-temperature and high-pressure aqueous solution is used to synthesize an inorganic powder and has the advantage that fine powders with uniform particle size can be manufactured at a relatively low cost. Manufacturing a multilayer ceramic capacitor using dielectric powders synthesized by the hydrothermal method (hydrothermally synthesized dielectric powders), therefore, allows for reducing the thickness of the dielectric layers and increasing their capacitance. Variations in the diameter of dielectric particles, furthermore, are reduced, which allows for improvements in the dielectric constant and reliability. In the hydrothermal method, hydroxides are used as raw

materials. For example, a Ba source, such as barium hydroxide (Ba(OH)₂), and a Ti source, such as a metatitanate (TiO(OH)₂) or titanium oxide (TiO₂), are allowed to react in high-temperature and high-pressure water, and the resulting reaction product is subjected to heat treatment to give a BaTiO₃ powder. The OH groups included in the hydroxides leave the raw materials during the heat treatment, but as a result of this, voids are created inside the particles of the dielectric powder (intragranular voids). Manufacturing a multilayer ceramic capacitor using dielectric powders having intragranular voids, furthermore, results in the intragranular voids remaining in the finished capacitor. When dielectric powders synthesized by methods other than the hydrothermal method are used, by contrast, no intragranular voids are created.

In Japanese Unexamined Patent Application Publication No. 2019-102655, the use of a hydrothermally synthesized dielectric powder in the dielectric layers of a multilayer ceramic capacitor is disclosed. Specifically, a method for manufacturing a ceramic capacitor is disclosed that includes a production step in which green sheets are produced using a ceramic slurry including a first ceramic powder synthesized by the hydrothermal method and a second ceramic powder synthesized by a method other than the hydrothermal method and a step of firing the resulting green sheets (see, for example, claim 5 of Japanese Unexamined Patent Application Publication No. 2019-102655). In Japanese Unexamined Patent Application Publication No. 2019-102655, furthermore, it is also stated that pores (voids) present within the ceramic particles alleviate piezoelectric strain, which leads to the reduction of cracks (see, for example, paragraph of Japanese Unexamined Patent Application Publication No. 2019-102655).

As described above, the manufacture of a multilayer ceramic capacitor using a hydrothermally synthesized dielectric powder has hitherto been proposed. As a result of studies by the inventors of example embodiments of the present invention, however, it was discovered that such a multilayer ceramic capacitor has a problem with moisture resistance. As a possible cause of this, furthermore, the presence of intragranular voids was suspected. More specifically, as stated above, multilayer ceramic capacitors made using a hydrothermally synthesized dielectric powder may have intragranular voids remaining in ceramic dielectrics. In addition, the inventors of example embodiments of the present invention considered that when intragranular voids remain in the ceramic dielectrics of the outer-layer portions or side margin portions, they result in reduced moisture resistance. The inventors of example embodiments of the present invention also speculated that when numerous intragranular voids remain simultaneously, denseness also decreases.

As a result of further investigation by the inventors of example embodiments of the present invention, it was discovered that a multilayer ceramic capacitor particularly superior in moisture resistance can be obtained by controlling the densities of intragranular voids in the inner-layer portion, outer-layer portions, and side margin portions of the multilayer ceramic capacitor such that they satisfy predetermined relationships.

### SUMMARY OF THE INVENTION

Example embodiments of the present invention provide multilayer ceramic capacitors each with superior moisture resistance.

It should be noted that a range expressed using “from” and “to” herein includes the values at both ends. That is, “from X to Y” is synonymous with “X or more and Y or less.”

According to an example embodiment of the present invention, a multilayer ceramic capacitor includes an inner-layer portion including at least one first inner electrode layer and at least one second inner electrode layer alternately stacked with at least one dielectric layer including a ceramic dielectric interposed therebetween, a first primary surface facing a stacking direction, a second primary surface opposite to the first primary surface, a first side surface facing a width direction, orthogonal or substantially orthogonal to the first primary surface and the second primary surface, and to which the first inner electrode layer and the second inner electrode layer are extended, a second side surface opposite to the first side surface and to which the first inner electrode layer and the second inner electrode layer are extended, a first end surface a length direction, orthogonal or substantially orthogonal to the first primary surface, the second primary surface, the first side surface, and the second side surface, and to which the first inner electrode layer is extended, and a second end surface opposite to the first end surface and to which the second inner electrode layer is extended, a first outer-layer portion including a ceramic dielectric and covering the first primary surface in the stacking direction, a second outer-layer portion including a ceramic dielectric and covering the second primary surface in the stacking direction, a first side margin portion including a ceramic dielectric and covering the inner-layer portion, the first outer-layer portion, and the second outer-layer portion from one side in the width direction, a second side margin portion including a ceramic dielectric and covering the inner-layer portion, the first outer-layer portion, and the second outer-layer portion from another side in the width direction, and a pair of outer electrodes on the first end surface and the second end surface and coupled to each of the first inner electrode layer and the second inner electrode layer, wherein each of the ceramic dielectrics of the inner-layer portion, the first outer-layer portion, the second outer-layer portion, the first side margin portion, and the second side margin portion includes multiple dielectric particles including a void therein, and an intragranular void density in the ceramic dielectric in the inner-layer portion (Nᵢₙₙₑᵣ), intragranular void densities in the ceramic dielectrics in the first outer-layer portion and the second outer-layer portion (Nₒᵤₜₑᵣ), and intragranular void densities in the ceramic dielectrics in the first side margin portion and the second side margin portion (N_{side}) satisfy both of Nₒᵤₜₑᵣ<Nᵢₙₙₑᵣ and N_{side}<Nᵢₙₙₑᵣ.

According to example embodiments of the present invention, multilayer ceramic capacitors each with superior moisture resistance are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating the external shape of a multilayer ceramic capacitor according to an example embodiment of the present invention.

FIG. 2 is a cross-sectional view schematically illustrating the internal structure of a multilayer ceramic capacitor according to an example embodiment of the present invention.

FIG. 3 is a cross-sectional view schematically illustrating the internal structure of a multilayer ceramic capacitor according to an example embodiment of the present invention.

### DETAILED DESCRIPTION OF THE EXAMPLE EMBODIMENTS

Example embodiments of the present invention will be described in detail below with reference to the drawings.

The present invention is not limited to the following example embodiments, and various modifications are possible within the gist and scope of the present invention.

### 1. Multilayer Ceramic Capacitor

A multilayer ceramic capacitor according to an example embodiment of the present invention includes an inner-layer portion, a first outer-layer portion, a second outer-layer portion, a first side margin portion, a second side margin portion, and a pair of outer electrodes. The inner-layer portion is a region in which first inner electrode layers and second inner electrode layers are alternately stacked with dielectric layers including a ceramic interposed therebetween. The inner-layer portion includes a first primary surface and a second primary surface, a first side surface and a second side surface, and a first end surface and a second end surface. The first primary surface is a surface facing the direction in which the dielectric layers, the first inner electrode layers, and the second electrode layers are stacked. The second primary surface is a surface opposite to the first primary surface. The first side surface is a surface facing the width direction, orthogonal or substantially orthogonal to the first primary surface and the second primary surface. The second side surface is a surface opposite to the first side surface. The first end surface is a surface facing the length direction, orthogonal or substantially orthogonal to the first primary surface, the second primary surface, the first side surface, and the second side surface, and to which the first inner electrode layers are extended. The second end surface is a surface opposite to the first end surface and to which the second inner electrode layers are extended. The first outer-layer portion, furthermore, includes a ceramic dielectric and covers the first primary surface in the stacking direction. The second outer-layer portion includes a ceramic dielectric and covers the second primary surface in the stacking direction. The first side margin portion includes a ceramic dielectric and covers the inner-layer portion, the first outer-layer portion, and the second outer-layer portion from one side in the width direction. The second side margin portion includes a ceramic dielectric and covers the inner-layer portion, the first outer-layer portion, and the second outer-layer portion from the other side in the width direction. The pair of outer electrodes are provided on the first end surface and the second end surface and are coupled to either the first inner electrode layers or the second inner electrode layers. Each of the ceramic dielectrics of the inner-layer portion, the first outer-layer portion, the second outer-layer portion, the first side margin portion, and the second side margin portion includes multiple dielectric particles including a void therein. Moreover, the intragranular void density in the ceramic dielectric in the inner-layer portion (Nᵢₙₙₑᵣ), the intragranular void densities in the ceramic dielectrics in the first outer-layer portion and the second outer-layer portion (Nₒᵤₜₑᵣ), and the intragranular void densities in the ceramic dielectrics in the first side margin portion and the second side margin portion (N_{side}) satisfy both formula (1): Nₒᵤₜₑᵣ<Nᵢₙₙₑᵣ and formula (2): N_{side}<Nᵢₙₙₑᵣ.

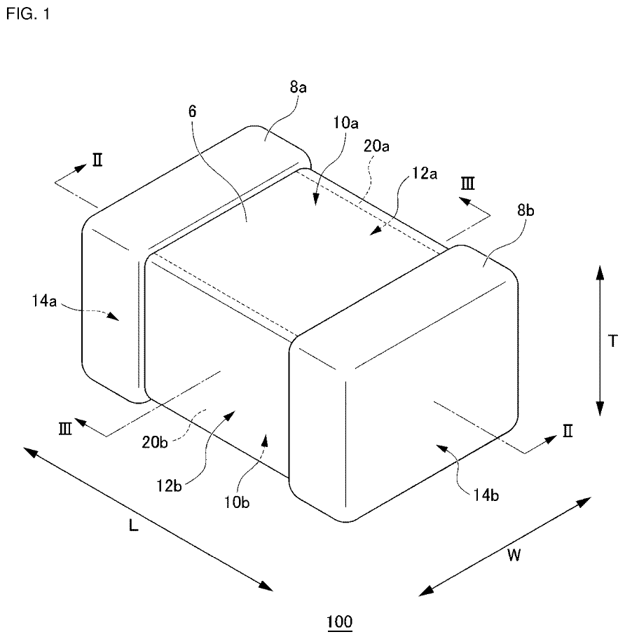

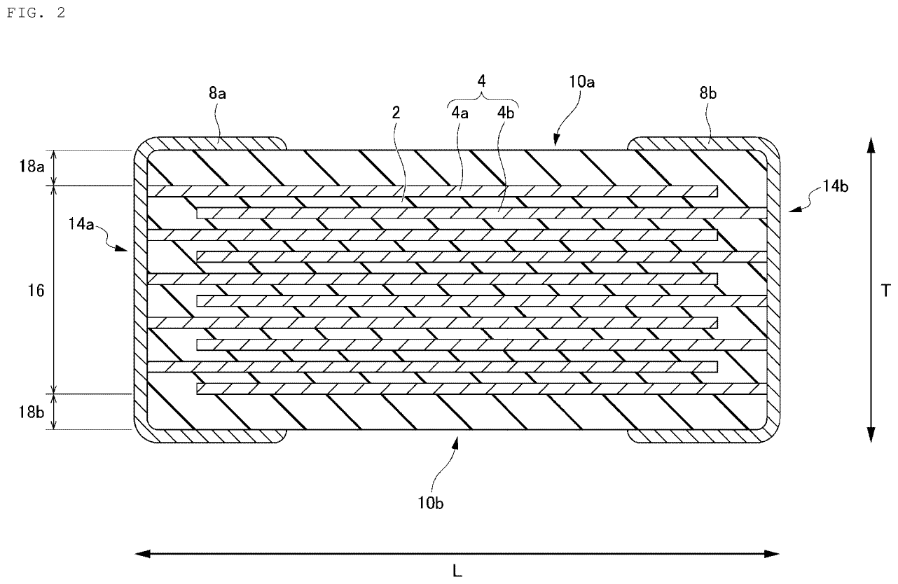

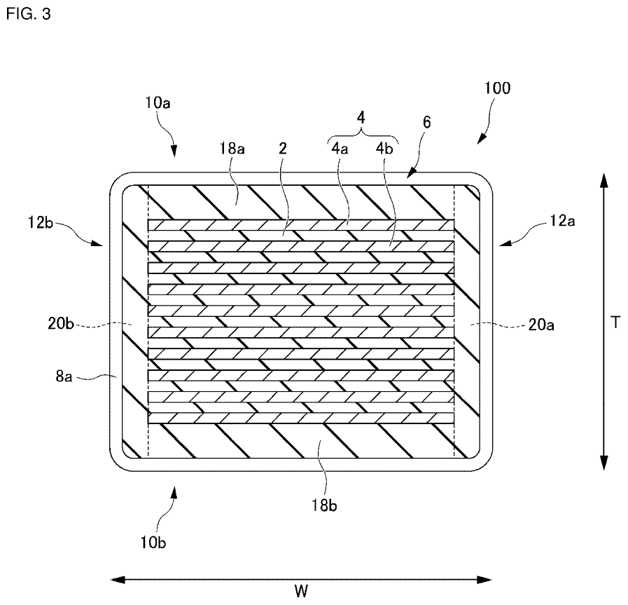

A configuration of a multilayer ceramic capacitor will be described using FIG. 1 to FIG. 3. FIG. 1 is a perspective view illustrating the external shape of the multilayer ceramic capacitor. FIG. 2 is a cross-section of the multilayer ceramic capacitor illustrated in FIG. 1 taken along line II-II, and FIG. 3 is a cross-sectional view of the multilayer ceramic capacitor illustrated in FIG. 1 taken along line III-III.

The multilayer ceramic capacitor (100) includes a body portion (6) and a pair of outer electrodes (8a, 8b) provided on both end surfaces (14a, 14b) of this body portion (6). The multilayer ceramic capacitor (100) and the body portion (6) have a rectangular or substantially rectangular parallelepiped shape. A substantially rectangular parallelepiped encompasses not only a rectangular parallelepiped but also a rectangular parallelepiped whose corner portions and/or edge portions are rounded.

The multilayer ceramic capacitor (100) and the body portion (6) include a first outer primary surface (10a) and a second outer primary surface (10b) facing each other in the thickness direction T, a first outer side surface (12a) and a second outer side surface (12b) facing each other in the width direction W, and a first outer end surface (14a) and a second outer end surface (14b) facing each other in the length direction L. In this context, the thickness direction T is the direction in which dielectric layers (2) and inner electrode layers (4), included in the body portion (6), are stacked. The length direction L is the direction that is orthogonal or substantially orthogonal to the thickness direction T and in which the outer end surfaces (14a, 14b) are opposite each other. The width direction W is the direction orthogonal or substantially orthogonal to the thickness direction T and the length direction L. A plane including the thickness direction T and the width direction W is defined as a WT plane, a plane including the width direction W and the length direction L is defined as an LW plane, and a plane including the length direction L and the thickness direction T is defined as an LT plane.

The body portion (6) includes an inner-layer portion (16), a first outer-layer portion (18a), a second outer-layer portion (18b), a first side margin portion (20a), and a second side margin portion (20b).

The inner-layer portion (16) is a region in which inner electrode layers (4) are alternately stacked with dielectric layers (2) interposed therebetween. The dielectric layers (2) include a ceramic dielectric. The inner electrode layers (4) include multiple first inner electrode layers (4a) and multiple second inner electrode layers (4b).

The inner-layer portion (16) includes a first primary surface, a second primary surface, a first side surface, a second side surface, a first end surface, and a second end surface. The first primary surface is a surface perpendicular or substantially perpendicular to the direction in which the dielectric layers (2) and the inner electrode layers (4a, 4b) are stacked. The second primary surface is the surface opposite (the surface facing) the first primary surface. The first side surface is a surface orthogonal or substantially orthogonal to the first primary surface and the second surface, i. e., primary a surface perpendicular or substantially perpendicular to the width direction W. The second side surface is the surface opposite (the surface facing) the first side surface. The first end surface is a surface orthogonal or substantially orthogonal to the first primary surface, the second primary surface, the first side surface, and the second side surface, i.e., a surface perpendicular or substantially perpendicular to the length direction L. The second end surface is the surface opposite (the surface facing) the first end surface. To the first side surface and the second side surface, the inner electrode layers (4a, 4b) are extended. In other words, on both of the first side surface side and the second side surface side, end portions of the inner electrode layers are exposed. To the first end surface, the first inner electrode layers (4a) are extended, but the second inner electrode layers (4b) are not extended. To the second end surface, the second inner electrode layers (4b) are extended, but the first inner electrode layers (4a) are not extended.

The first outer-layer portion (18a) is a region that covers the first primary surface of the inner-layer portion (16) in the stacking direction (thickness direction T). The second outer-layer portion (18b) is a region that covers the second primary surface of the inner-layer portion (16) in the stacking direction. The first side margin portion (20a) is a region that covers the inner-layer portion (16), the first outer-layer portion (18a), and the second outer-layer portion (18b) from one side in the width direction (first side surface side). The second side margin portion (20a) is a region that covers the inner-layer portion (16), the first outer-layer portion (18a), and the second outer-layer portion (18b) from the other side in the width direction (second side surface side). The first outer-layer portion (18a), the second outer-layer portion (18b), the first side margin portion (20a), and the second side margin portion (20b) are formed of ceramic dielectrics.

The outer electrodes (8a, 8b) include a first outer electrode (8a) provided on the first outer end surface (14a) of the body portion (6) and a second outer electrode (8b) provided on the second outer end surface (14b). The first outer electrode (8a) and the second outer electrode (8b) are not in contact with each other, and are instead, electrically separated.

The sizes of the multilayer ceramic capacitor (100) and the body portion (6) are not particularly limited. For example, the dimension in the length direction L is about 0.2 mm or more and about 3.2 mm or less, the dimension in the width direction W is about 0.1 mm or more and about 2.5 mm or less, and the dimension in the stacking direction T is about 0.1 mm or more and about 2.5 mm or less. Although in FIGS. 1 to 3 the multilayer ceramic capacitor is illustrated such that the dimension in the length direction L is greater than the dimension in the width direction W, the multilayer ceramic capacitor according to the present example embodiment is not limited to ones having such dimensions. The dimension in the length direction L may be smaller than the dimension in the width direction W.

### Inner-Layer Portion-Dielectric Layers

The inner-layer portion is a region in which inner electrode layers (first inner electrode layers and second inner electrode layers) are alternately stacked with dielectric layers including a ceramic dielectric interposed therebetween. The dielectric layers include a ceramic dielectric produced by firing inner-layer green sheets, which include a dielectric raw material. The ceramic dielectric is based on a sintered polycrystal (ceramic) in which numerous dielectric particles are bound together with grain boundaries and triple points interposed therebetween. In other words, the ceramic dielectric includes dielectric particles (dielectric grains) as its primary component. The primary component has the highest percentage, or at least about 50% by mass or more, for example, in the ceramic dielectric.

The dielectric particles include a perovskite oxide. A perovskite oxide has a composition represented by the general formula: ABO₃, and has a cubic crystal structure, such as, for example, cubic, tetragonal, orthorhombic, or rhombohedral, at room temperature. Each of the atoms of the A-site element (hereinafter “A-site atoms”) and the atoms of the B-site element (hereinafter “B-site atoms”), furthermore, becomes ionized and occupies the A-site or B-site in the perovskite structure. Examples of A-site elements include elements with relatively large ionic sizes, such as barium (Ba), calcium (Ca), and strontium (Sr), and examples of B-site elements include elements with relatively small ionic sizes, such as titanium (Ti), zirconium (Zr), and hafnium (Hf). The combination of the A-site element and the B-site element is not particularly limited, as long as the perovskite structure is maintained. Each of the A-site element and the B-site element may include only one element or may alternatively include multiple elements in combination. Moreover, as long as the perovskite structure is maintained, the molar ratio between the A-site element and the B-site element may deviate from 1:1.

Specific examples of perovskite oxides include barium titanate (BaTiO₃) compounds, calcium titanate (CaTio₃) compounds, strontium titanate (SrTiO₃) compounds, and their mixed crystals and solid solutions. Preferably, for example, the A-site element includes barium (Ba), with the B-site element including titanium (Ti). That is, the perovskite oxide is, for example, preferably a barium titanate (BaTiO₃) compound. BaTiO₃ compounds encompass not only BaTiO₃ but also compounds in which a portion of the Ba in BaTiO₃ has been replaced with other A-site elements, such as, for example, Sr and/or Ca, or compounds in which a portion of the Ti in BaTiO₃ has been replaced with other B-site elements, such as, for example, Zr and/or Hf.

The ceramic dielectric may include secondary components. Examples of secondary components include rare earth elements (REs), magnesium (Mg), manganese (Mn), iron (Fe), chromium (Cr), cobalt (Co), nickel (Ni), silicon (Si), aluminum (Al), vanadium (V), and their compounds, although not limited. The ceramic dielectric may include one such component alone as a secondary component or may include multiple components in combination. The form in which the secondary components exist is not limited. The secondary components only need to be included in any of the dielectric particles, grain boundaries, or triple points.

The dielectric particles may include, for example, core-shell particles. A core-shell particle refers to a particle having a structure in which at least a subset of secondary components is dissolved at high concentrations in the surface layer (shell portion) of the particle, with the secondary components being dissolved at low concentrations or the secondary components not dissolved in the middle portion (core portion) of the particle (core-shell structure). Alternatively, for example, the dielectric particles may include uniform solid-solution particles.

The thickness of the dielectric layers occupying the inner-layer portion is, for example, preferably about 0.3 μm or more and about 0.5 μm or less. Setting the thickness of the dielectric layers equal to or greater than a predetermined value allows for reducing the occurrence of dielectric breakdown during the use of the multilayer ceramic capacitor and service life degradation. Setting the thickness of the dielectric layers equal to or smaller than a predetermined value, furthermore, allows for further increasing the capacitance of the multilayer ceramic capacitor because the dielectric layers are formed as thin layers. The number of dielectric layers is not particularly limited. Preferably, for example, the number of dielectric layers of the outer-layer portions and the inner-layer portion is 100 or more and 2000 or fewer.

### Inner-Layer Portion-Inner Electrode Layers

The inner electrode layers (the first inner electrode layers and the second inner electrode layers) include a facing electrode portion and an extended electrode portion and define the inner-layer portion together with the dielectric layers. The facing electrode portion acts to allow the dielectric layers to provide their function as capacitive elements by sandwiching them. The extended electrode portion acts to electrically couple the facing electrode portion and the outer electrodes. The inner electrode layers include at least one conductive metal. The conductive metal can be any one or more known electrode materials, such as, for example, nickel (Ni), copper (Cu), silver (Ag), palladium (Pd), a silver (Ag)-palladium (Pd) alloy, and/or gold (Au). The inner electrode layers are produced by sintering conductive paste layers formed on the surface of inner-layer green sheets by printing, for example.

The inner electrode layers may include additional components, other than the conductive metal. An example of an additional component is a ceramic component that acts as a common material. The thickness of the inner electrode layers, furthermore, is, for example, preferably about 0.30 μm or more and about 0.40 μm or less. By setting the thickness of the inner electrodes equal to or greater than a predetermined value, the occurrence of problems such as broken electrodes can be prevented. By setting the thickness equal to or smaller than a predetermined value, furthermore, a decrease in the percentage that the dielectric layers constitute in the capacitor can be prevented, contributing to increasing the capacitance. Moreover, the number of inner electrode layers is, for example, preferably 10 or more and 1000 or fewer.

### Outer-Layer Portions

The outer-layer portions (the first outer-layer portion and the second outer-layer portion) are provided above and below the inner-layer portion, one on each side. The outer-layer portions are regions including ceramic dielectrics and no inner electrode layer therein. The outer-layer portions are produced by firing outer-layer green sheets, which include a dielectric raw material.

### Side Margin Portions

The side margin portions (the first side margin portion and the second side margin portion) are provided along the side surfaces of the multilayer ceramic capacitor to sandwich the inner-layer portion and the outer-layer portions. The side margin portions are also referred to as the side gap portions or side portions. The side margin portions are regions including ceramic dielectrics and no inner electrode layer therein. By providing the side margin portions, the penetration of water into the inner-layer portion through the side surfaces can be prevented.

The side margin portions are formed separately from the inner-layer portion and the outer-layer portions during the manufacture of the multilayer ceramic capacitor. Specifically, the multilayer ceramic capacitor can be manufactured by producing a green body portion by attaching side-margin green bodies to the side surfaces of a multilayer chip, which will become the inner-layer portion and the outer-layer portions, and firing this green body portion. In that case, the ceramic dielectrics of the side margin portions have a composition and/or a microscopic structure discontinuous with those of the ceramic dielectric(s) of the inner-layer portion and/or the outer-layer portions. Between the side margin portions and the inner-layer portion and/or the outer-layer portions, therefore, physical or chemical boundaries exist.

### Outer Electrodes

The outer electrodes (the first outer electrode and the second outer electrode) define and function as input/output terminals of the multilayer ceramic capacitor. The first outer electrode and the second outer electrode are provided on both end surfaces of the multilayer ceramic capacitor. The first outer electrode is coupled to the first inner electrode layers, and the second outer electrode is coupled to the second inner electrode layers. For the outer electrodes, known configurations can be used. For example, the outer electrodes may include a base electrode layer and a plating layer disposed on it. Alternatively, the outer electrodes may include only a plating layer, without providing a base electrode layer.

### Intragranular Void Densities

In the multilayer ceramic capacitor according to the present example embodiment, each of the ceramic dielectrics of the inner-layer portion, the first outer-layer portion, the second outer-layer portion, the first side margin portion, and the second side margin portion includes multiple dielectric particles including a void therein. That is, these ceramic dielectrics are produced using hydrothermally synthesized dielectric powders.

In the multilayer ceramic capacitor according to the present example embodiment, furthermore, the intragranular void density in the ceramic dielectric in the inner-layer portion (Hereinafter also collectively referred to as “the inner-layer ceramic.”) (Nᵢₙₙₑᵣ), the intragranular void densities in the ceramic dielectrics in the outer-layer portions (the first outer-layer portion and the second outer-layer portion) (Hereinafter also collectively referred to as “the outer-layer ceramics.”) (Nₒᵤₜₑᵣ), and the intragranular void densities in the ceramic dielectrics in the side margin portions (the first side margin portion and the second side margin portion) (Hereinafter also collectively referred to as “the side-margin ceramics.”) (N_{side}) satisfy both formula (1): Nₒᵤₜₑᵣ<Nᵢₙₙₑᵣ and formula (2): N_{side}<Nᵢₙₙₑᵣ. In this context, an intragranular void density is the number of intragranular voids per unit area in a cross-section that passes through the middle portion in the length direction (WT plane) of the multilayer ceramic capacitor. An intragranular void, furthermore, is a void present inside a dielectric particle of a ceramic dielectric. In other words, an intragranular void is a region present inside a dielectric particle and including no solid component, such as the primary component of the dielectric particle or intentionally added secondary components. An intragranular void, therefore, is distinguished from an extragranular void, which is present at a boundary or triple point between particles. A particle including a void therein is referred to as a voided particle.

Controlling the intragranular void density(ies) in each of the inner-layer ceramic, the outer-layer ceramics, and the side-margin ceramics to satisfy the relationships specified above allows for achieving the advantage of improved moisture resistance while ensuring the advantage provided by intragranular voids in the inner-layer portion.

To describe this, the inner-layer ceramic is a region having the function as a capacitive element. Providing intragranular voids in the inner-layer ceramic allows for improving characteristics of the multilayer ceramic capacitor. As stated earlier, intragranular voids are created by using a hydrothermally synthesized dielectric powder as a raw material. Using a hydrothermally synthesized dielectric powder, on the other hand, allows for reducing the thickness of the multilayer ceramic capacitor and increasing its capacitance. Variations in the diameter of dielectric particles, furthermore, are reduced, which allows for improvements in the dielectric constant and reliability. In addition to these, particles including an intragranular void (voided particles) has high crystallinity in the periphery of the void, helping to reduce the occurrence of problems caused by the diffusion of secondary component elements. As a result, improvements in characteristics can be obtained. For example, when the dielectric particles are core-shell particles, the diffusion and dissolution of secondary components do not proceed more than necessary, even if grain growth is induced in the firing step. Because grain growth can occur without destructing the core-shell structure, a high dielectric constant combined with flat temperature profiles and excellent reliability can be obtained.

When the thickness of the dielectric layers is, for example, about 0.5 μm or less, it is preferable that the intragranular void density in the inner-layer ceramic (Nᵢₙₙₑᵣ) is relatively high to obtain conforming products and to ensure reliability. Nᵢₙₙₑᵣ is, for example, preferably about 8 voids/μm² or more and about 23 voids/μm² or less, and more preferably about 11 voids/μm² or more and about 23 voids/μm² or less. An intragranular void density can be determined by observing a cross-section that passes through the middle portion in the length direction (WT plane) of the multilayer ceramic capacitor using a transmission electron microscope (TEM). Specifically, an 80-nm thick TEM observation sample including a WT plane is prepared. The resulting sample is observed using a TEM in a 2-μm square field of view, and the number of intragranular voids is counted. Then the number of voids per unit area (1 μm²) is calculated by dividing the obtained number by the area of the ceramic portion (dielectric layer), the same operation is performed at three points (n =3), and the average number of intragranular voids per unit area is determined as the intragranular void density. In addition, the average diameter of the voids is, for example, preferably about 10 nm or more and about 50 nm or less, and particularly preferably about 10 nm or more and about 30 nm or less.

In contrast, the outer-layer ceramics and the side-margin ceramics, which surround the inner-layer ceramic, do not act as capacitive elements. When the outer-layer ceramics or side-margin ceramics have an excessively large number of intragranular voids, moisture resistance may decrease. More specifically, the outer-layer ceramics and the side-margin ceramics include no inner electrode layer. They are not affected by the stress from the inner electrode layers in the firing step during the manufacture of the multilayer ceramic capacitor and thus tend to have low sinterability compared to the inner-layer ceramic. When the outer-layer ceramics or side-margin ceramics, which have low sinterability, include intragranular voids, it becomes easier for water in the external environment to penetrate through these voids. The water that penetrates can reach the inner-layer ceramic, which acts as a capacitive element, potentially causing problems such as reduced insulation resistance.

Limiting the intragranular void densities in the outer-layer ceramics and the side-margin ceramics to be smaller than the intragranular void density in the inner-layer ceramic, therefore, achieves the advantage of improved moisture resistance while ensuring the advantage provided by the intragranular voids in the inner-layer ceramic. For this reason, in the present example embodiment, satisfying both formula (1): Nₒᵤₜₑᵣ<Nᵢₙₙₑᵣ and formula (2): N_{side}<Nᵢₙₙₑᵣ is preferable.

It is, however, effective to provide certain quantities of intragranular voids in the outer-layer ceramics and the side-margin ceramics, provided that formula (1) and formula (2) above are satisfied. More specifically, to reduce the thickness of the dielectric layers in the inner-layer portion and thus improve reliability, it is necessary to limit variations in the diameter of dielectric particles across the entire or substantially the entire electrically effective inner-layer ceramic. In limiting variations in particle diameter in the effective portions of the inner-layer ceramic that are in contact with the outer-layer ceramics or the side-margin ceramics, the presence of intragranular voids in the outer-layer ceramics or side-margin ceramics is advantageous, regardless of the quantity.

From the viewpoint of reducing the thickness of the dielectric layers and improving reliability while maintaining excellent moisture resistance, it is preferable that the intragranular void densities in the outer-layer ceramics (Nₒᵤₜₑᵣ) is, for example, about 3 voids/μm² or more and about 13 voids/μm² or less, and more preferably about 3 voids/μm² or more and about 11 voids/μm² or less, provided that formula (1) and formula (2) above are satisfied. For the same or similar reasons, the intragranular void densities in the side-margin ceramics (N_{side}) are, for example, preferably about 3 voids/μm² or more and about 13 voids/μm² or less, and more preferably about 3 voids/μm² or more and about 11 voids/μm² or less.

The outer-layer ceramics include a section corresponding to the first outer-layer portion and a section corresponding to the second outer-layer portion. The intragranular void density in the section corresponding to the first outer-layer portion and the intragranular void density in the section corresponding to the second outer-layer portion may be the same or may alternatively be different. As long as both are smaller than the intragranular void density in the inner-layer ceramic, their numerical relationship is not limited. Similarly, the side-margin ceramics include a section corresponding to the first side margin portion and a section corresponding to the second side margin portion, but the intragranular void density in the section corresponding to the first side margin portion and the intragranular void density in the section corresponding to the second side margin portion may be the same or may alternatively be different.

According to an example configuration, for example, the zirconium (Zr) concentration in the inner-layer ceramic (Zrᵢₙₙₑᵣ), the zirconium (Zr) concentrations in the outer-layer ceramics (Zrₒᵤₜₑᵣ), and the zirconium (Zr) concentrations in the side-margin ceramics (Zr_{side}) satisfy both formula (3): Zrᵢₙₙₑᵣ<Zᵣₒᵤₜₑᵣ and formula (4): Zrᵢₙₙₑᵣ<Zr_{side}. As will be described later, adding grain growth accelerator materials, such as Zr, for example, to the outer-layer green sheets and the side-margin green bodies and setting their amounts higher than those in the inner-layer green sheets during the manufacture of the multilayer ceramic capacitor would help limit the intragranular void densities in the outer-layer portions and the side margin portions. In that case, furthermore, the concentrations of the grain growth accelerator materials (such as Zr) in the outer-layer ceramics and the side-margin ceramics would be higher than those in the inner-layer ceramic in the finally obtained multilayer ceramic capacitor.

In the example configuration described above, the Zr concentration in the section corresponding to the first outer-layer portion and the Zr concentration in the section corresponding to the second outer-layer portion may be the same or may alternatively be different, as long as both are higher than the Zr concentration in the inner-layer ceramic. Similarly, the Zr concentration in the section corresponding to the first side margin portion and the Zr concentration in the section corresponding to the second side margin portion may be the same or may alternatively be different.

According to another example configuration, the average diameter of dielectric particles in the inner-layer ceramic (D50ᵢₙₙₑᵣ), the average diameters of dielectric particles in the outer-layer ceramics (D50ₒᵤₜₑᵣ), and the average diameters of dielectric particles in the side-margin ceramics (D50_{side}) satisfy both formula (5): D50ᵢₙₙₑᵣ<D50ₒᵤₜₑᵣ and formula (6): D50ᵢₙₙₑᵣ<D50_{side}. By accelerating grain growth in the outer-layer ceramics and the side-margin ceramics during the manufacture of the multilayer ceramic capacitor, the intragranular void densities can be limited.

In the example configuration described above, the average particle diameter in the section corresponding to the first outer-layer portion and the average particle diameter in the section corresponding to the second outer-layer portion may be the same or may alternatively be different, as long as both are larger than the average particle diameter in the inner-layer ceramic. Similarly, average particle diameter in the section corresponding to the first side margin portion and the average particle diameter in the section corresponding to the second side margin portion may be the same or may alternatively be different.

Preferably, the average diameter of dielectric particles in the inner-layer ceramic (D50ᵢₙₙₑᵣ) is, for example, about 130 nm or more and about 210 nm or less. By setting the average particle diameter equal to or greater than a predetermined value, it can be ensured that the particles have crystallinity, and that the advantages of improved characteristics associated with it are produced. By setting the average particle diameter equal to or smaller than a predetermined value, furthermore, the thickness of the dielectric layers can be reduced, which increases the capacitance of the multilayer ceramic capacitor and effectively improves reliability. These average particle diameters are the average diameters of the entire populations of dielectric particles, including not only voided particles but also particles including no void.

As long as both of the intragranular void densities in the outer-layer ceramics (Nₒᵤₜₑᵣ) and the intragranular void densities in the side-margin ceramics (N_{side}) are smaller than the intragranular void density in the inner-layer ceramic (Nᵢₙₙₑᵣ), the numerical relationship between Nₒᵤₜₑᵣ and N_{side} is not limited. Nᵢₙₙₑᵣ, Nₒᵤₜₑᵣ, and N_{side} may satisfy formula (7): Nₒᵤₜₑᵣ<N_{side}<Nᵢₙₙₑᵣ. In that case, a reduced occurrence of cracks in the multilayer ceramic capacitor can be expected. More specifically, when a multilayer ceramic capacitor is mounted on a board, the surface mounting machine (mounter) may strike an outer-layer portion of the capacitor, and a crack may develop in the outer-layer portion due to the impact. It is anticipated that by limiting the intragranular void densities in the outer-layer ceramics (Nₒᵤₜₑᵣ), the formation of cracks in the outer-layer portions can be reduced.

Alternatively, Nᵢₙₙₑᵣ, Nₒᵤₜₑᵣ, and N_{side} may satisfy formula (8): N_{side}<Nₒᵤₜₑᵣ<Nᵢₙₙₑᵣ. In this case, a reduction in the chipping of the multilayer ceramic capacitor can be expected. More specifically, during handling, an edge portion of a multilayer ceramic capacitor may be subjected to impact, and chipping may occur there. It is anticipated that by limiting the intragranular void densities in the side-margin ceramics (N_{side}), the occurrence of chipping at the edge portions can be reduced.

### 2. Method for Manufacturing the Multilayer Ceramic Capacitor

For the multilayer ceramic capacitor according to the present example embodiment, a method for manufacturing is not limited as long as it satisfies the requirements described above. An example of a manufacturing method, however, includes the following steps: a step of synthesizing primary component powders for ceramic dielectrics (synthesis step), a step of mixing secondary component raw materials into the primary component powders to obtain dielectric raw materials (mixing step), a step of adding a binder and a solvent to the dielectric raw materials, mixing them to form slurries, and shaping the resulting slurries into inner-layer green sheets and outer-layer green sheets (shaping step), a step of forming a patterned conductive paste layer on the surface of the inner-layer green sheets using a conductive paste for inner electrodes (printing step), a step of stacking multiple inner-layer green sheets with the conductive paste layer formed thereon, placing the outer-layer green sheets on the top and bottom of the stack, and pressure-bonding the entire structure to produce a multilayer block (stacking step), a step of cutting the resulting multilayer block into multilayer chips (cutting step), a step of attaching side-margin green bodies to the side surfaces of the resulting multilayer chips to produce green body portions (side margin portion formation step), a step of subjecting the resulting green body portions to debinding treatment and firing treatment to convert them into body portions (firing step), and a step of forming outer electrodes on the resulting body portions to produce multilayer ceramic capacitors (outer electrode formation step). The manufacturing conditions, furthermore, are controlled such that in the resulting multilayer ceramic capacitors, the intragranular void density in the inner-layer ceramic (Nᵢₙₙₑᵣ), the intragranular void densities in the outer-layer ceramics (Nₒᵤₜₑᵣ), and the intragranular void densities in the side-margin ceramics (N_{side}) satisfy both formula (1): Nₒᵤₜₑᵣ<Nᵢₙₙₑᵣ and formula (2): N_{side}<Nᵢₙₙₑᵣ. The details of each step will be described below.

### Synthesis Step

In the synthesis step, primary component powders used to form ceramic dielectrics are synthesized. The primary component powders are powders of dielectrics having a perovskite structure (ABO₃), such as BaTiO₃ compounds, for example. As the primary component powders, hydrothermally synthesized dielectric powders are used. This allows for producing multilayer ceramic capacitors including dielectric particles including a void therein (voided particles). As each primary component powder, a hydrothermally synthesized dielectric powder alone may be used, or, alternatively, a hydrothermally synthesized dielectric powder and a powder synthesized by a method other than the hydrothermal method may be used in combination. In addition, particle diameters may be adjusted by crushing the synthesized primary component powders.

The synthesis of the hydrothermally synthesized dielectric powders is performed by subjecting a raw material including the A-site element constituting the perovskite structure (A-site raw material) and a raw material including the B-site element (B-site raw material) to hydrothermal reaction under high-temperature and high-pressure conditions. Specifically, placing the raw materials into a tightly sealed vessel, such as an autoclave, for example, together with water and heating them causes hydrothermal reaction. The A-site raw material is a hydroxide, such as barium hydroxide (Ba(OH)₂), for example. The B-site raw material is an oxide, such as, for example, titanium oxide (TiO₂) or metatitanic acid (TiO(OH)₂), or its hydrate. The heating temperature can be, for example, about 150° C. or above and about 250 or below, although not limited. By drying the product obtained through the hydrothermal reaction, a dielectric powder can be obtained. To increase the crystallinity of the dielectric powder, furthermore, the product may be subjected to heat treatment. The heat treatment can be performed at a temperature of, for example, about 800° C. or above and about 1000° C. or below.

### Mixing Step

In the mixing step, secondary component (e.g., Ni, Re, Mg, Mn, Si, Al, and V) raw materials are mixed into the primary component powders to give dielectric raw materials. The secondary component raw materials can be known ceramic raw materials, such as, for example, oxides, carbonates, hydroxides, nitrates, organic acid salts, alkoxides, and/or chelate compounds. Besides the secondary component raw materials, furthermore, a composition-controlling agent for the primary component powder may be added. For example, adding a Ba raw material, such as barium carbonate (BaCO₃), when the primary component powders are barium titanate (BaTiO₃) powders help control the composition of the primary component of the ceramic dielectrics included in the multilayer ceramic capacitors. The mixing method is not particularly limited. An example is the method of weighing out the primary component powder and the secondary component raw materials and mixing and grinding them by a wet process, together with a grinding medium and water, using a ball mill. When the mixing is performed by a wet process, the mixture can be dried.

### Shaping Step

In the shaping step, a binder and a solvent are added to the dielectric raw materials, the materials are mixed to form slurries, and the resulting slurries are shaped into inner-layer green sheets and outer-layer green sheets. The binder can be a known organic binder, such as a polyvinyl butyral binder, for example. The solvent, furthermore, can be a known organic solvent, such as toluene or ethanol, for example. Additives, such as a plasticizer, for example, may optionally be added. The shaping can be performed by a known method, such as RIP, for example. The thickness of the shaped sheets is, for example, about 1 μm or less.

### Printing Step

In the printing step, a patterned conductive paste layer is formed on the surface of the inner-layer green sheets using a conductive paste. The conductive paste layer forms an inner electrode layer after firing. The conductive metal included in the conductive paste can be a conductive material such as, for example, nickel (Ni), copper (Cu), silver (Ag), palladium (Pd), or an alloy including such metals. In addition, a ceramic component that acts as a common material may be added to the conductive paste. The ceramic component can be the primary component powder for the dielectric layers. The method for forming the conductive paste layer is not particularly limited. Examples include methods such as screen printing and gravure printing.

### Stacking Step

In the stacking step, multiple inner-layer green sheets with the conductive paste layer formed thereon are stacked, and the outer-layer green sheets are placed on the top and bottom of the stack. Then the entire structure is pressure-bonded to produce a multilayer block. The inner-layer green sheets form the ceramic dielectric of the inner-layer portion of the multilayer ceramic capacitors (the inner-layer ceramic) through the firing step. The outer-layer green sheets form the ceramic dielectrics of the outer-layer portions (the outer-layer ceramics). The number of green sheets stacked can be adjusted such that the required capacitance is achieved.

### Cutting Step

In the cutting step, the resulting multilayer block is cut into multilayer chips. The cutting can be performed such that chips of a predetermined size are obtained, and such that the conductive paste layers are exposed on the end surfaces and side surfaces of the multilayer chips.

### Side Margin Portion Formation Step

In the side margin portion formation step, side-margin green bodies are attached to the side surfaces of the multilayer chips to produce green body portions. By the side-margin green bodies, the conductive paste layers exposed on the side surfaces of the multilayer chips are covered. The side-margin green bodies, furthermore, form the side margin portions of the multilayer ceramic capacitors after firing. The raw materials for the side-margin green bodies (raw material powders for the side margin portions) can be, for example, the primary component powder and secondary component raw materials used to produce the inner-layer green sheets.

The production and attachment of the side-margin green bodies can be performed by known methods. An example is the method of producing green sheets from the dielectric raw material intended as a raw material for the side margin portions and attaching these green sheets to the side surfaces of the multilayer chips. In this process, an adhesive adjunct, such as an organic solvent, for example, may be applied to the side surfaces of the multilayer chips beforehand to ensure the bonding of the green sheets. An alternative example is the method of producing a paste from the dielectric raw material, applying this paste to the side surfaces of the multilayer chips, and drying the applied paste. The side-margin green bodies may be single-layer or may alternatively be multilayer bodies, including of multiple layers. Side-margin green bodies that are multilayer bodies can be obtained by the method of stacking multiple green sheets on the side surfaces of the multilayer chips or the method of repeating the application and drying of a paste, for example.

The resulting green body portions may optionally be subjected to barrel polishing treatment. This treatment allows for rounding the corner portions and/or edge portions of the green body portions.

### Firing Step

In the firing step, the green body portions are subjected to debinding treatment and firing treatment to convert them into body portions. Through the firing treatment, the conductive paste layers and the inner-layer green sheets are co-sintered, forming the inner electrode layers and ceramic dielectric of the inner-layer portion. The outer-layer green sheets are sintered to form the ceramic dielectrics of the outer-layer portions. The side-margin green bodies are sintered to form the ceramic dielectrics of the side margin portions.

The conditions for the debinding treatment can be determined according to the types of organic binders included in the green sheets and the conductive paste layers. The firing treatment, furthermore, can be performed at a temperature at which the multilayer chips are densified sufficiently. For example, it can be performed under conditions under which the chips are held at a temperature of about 1200° C. or above and about 1300° C. or below for about 0 minutes or more and about 10 minutes or less. The firing, moreover, for example, is performed in an atmosphere in which the primary component compound, such as BaTiO₃, is not reduced and in which the oxidation of the conductive material is limited. For example, it can be performed in a N₂—H₂—H₂O gas stream with a partial pressure of oxygen of about 1.8×10⁻⁹ to about 8.7×10⁻¹⁰ MPa. In addition, annealing treatment may be applied after the firing.

### Outer Electrode Formation Step

In the outer electrode formation step, outer electrodes are formed on the body portions to complete multilayer ceramic capacitors. The formation of the outer electrodes can be performed by a known method. For example, a conductive paste including a conductive component, such as Cu or Ni, as its primary component is applied to the end surfaces of the body portions, on which extended inner electrodes are exposed, and baked to form a base layer. The base layer may be formed by, for example, the method of applying a conductive paste to both end surfaces of the green body portions, which have yet to be fired, and then subjecting the green body portions to firing treatment. After the formation of the base layer, a plating coating, for example of Ni or Sn, can be formed on the surface of the base layer by applying electrolytic plating. Through this, multilayer ceramic capacitors are produced.

Control of Intragranular Void Densities

In the manufacturing method according to the present example embodiment, it is important to control the intragranular void densities in the inner-layer ceramic, the outer-layer ceramics, and the side-margin ceramics (Nᵢₙₙₑᵣ, Nₒᵤₜₑᵣ, and N_{side}). Specifically, the manufacturing conditions are controlled such that the intragranular void densities satisfy both formula (1): Nₒᵤₜₑᵣ<Nᵢₙₙₑᵣ and formula (2): N_{side}<Nᵢₙₙₑᵣ.

The method for controlling the intragranular void densities is not limited. An example is the method of adding grain growth accelerator materials or grain growth inhibitor materials to the primary component powders and adjusting their amounts. Examples of grain growth accelerator materials include zirconium (Zr), silicon (Si), vanadium (V), and/or aluminum (Al). The dielectric particles grow during the firing step. In this process, intragranular voids become smaller as grain growth proceeds and, in some cases, disappear. Adding grain growth accelerator materials to the outer-layer green sheets and the side-margin green bodies and setting their amounts higher than those in the inner-layer green sheets, therefore, would help limit the intragranular void densities in the outer-layer ceramics and the side-margin ceramics. In that case, the concentrations of the grain growth accelerator materials (such as Zr) in the outer-layer ceramics and the side-margin ceramics would be higher than those in the inner-layer ceramic in the finally obtained multilayer ceramic capacitors.

An alternative example is the method of adjusting the composition of the primary component powders. The primary component powders are perovskite oxides, which have a composition represented by the formula: ABO₃, typified by BaTiO₃. For perovskite oxides, grain growth is accelerated with decreasing molar ratio of the A-site element (e.g., Ba) to the B-site element (e.g., Ti) (A/B ratio). Reducing the molar ratios (A/B ratios) in the primary component powders for the outer-layer green sheets and the side-margin green bodies, therefore, would help limit the intragranular void densities in the outer-layer ceramics and the side-margin ceramics.

In addition, the method of adjusting the particle diameter of raw material particles, such as the primary component powders, is also possible. The smaller the raw material particles, the faster grain growth proceeds. By using powders with particle diameters smaller than that of the primary component powder for the inner-layer green sheets as the primary component powders for the outer-layer green sheets and the side-margin green bodies, therefore, the intragranular void densities in the outer-layer ceramics and the side-margin ceramics can be limited.

Another possible method is the method of adding a dielectric powder synthesized by a method other than the hydrothermal method, such as, for example, the solid-phase method, to the primary component powders. As stated earlier, whereas hydrothermally synthesized dielectric powders include intragranular voids, dielectric powders synthesized by methods other than the hydrothermal method include no intragranular voids. By using a hydrothermally synthesized dielectric powder and a dielectric powder synthesized by a method other than the hydrothermal method in combination, therefore, the intragranular void densities can be controlled. A specific example is the method of producing the inner-layer green sheets from a hydrothermally synthesized dielectric powder while producing the outer-layer green sheets and the side-margin green bodies from a mixture of a hydrothermally synthesized dielectric powder and a dielectric powder synthesized by the solid-phase method.

As long as the intragranular void densities in the inner-layer ceramic, the outer-layer ceramics, and the side-margin ceramics can be controlled to satisfy the predetermined relationships, the method for controlling the intragranular void densities is not limited.

### EXAMPLES

The present example embodiment will be more specifically described using the following examples and comparative examples. The present invention, however, is not limited to the following examples.

### (1) Production of Multilayer Ceramic Capacitors

### Example 1

In Example 1 of an example embodiment of the present invention, inner-layer green sheets, outer-layer green sheets, and side-margin green bodies were produced using a barium titanate (BaTiO₃) powder synthesized by the hydrothermal method as the primary component powder, and multilayer ceramic capacitors were produced using them. The specific production procedure is presented below.

### Synthesis of the Primary Component Powder

A barium titanate (BaTiO₃) powder was synthesized by the hydrothermal method. First, a titanium oxide (TiO₂) powder and a barium hydroxide (Ba(OH)₂) powder were weighed out, and purified water was added to them to produce a slurry. Then the produced slurry was placed into a tightly sealed vessel, and the temperature of the slurry was raised to about 200° C. to about 250° C. with stirring. Then the slurry was maintained at about 200° C. to about 250° C. for 4 to about 24 hours to allow a liquid-phase reaction to proceed. After that, the internal pressure of the tightly sealed vessel was returned to atmospheric pressure, the heating of the tightly sealed vessel was terminated, and the slurry was allowed to stand. After cooling, the slurry was removed from the tightly sealed vessel and placed into a drying oven, followed by the evaporation of water. In such a manner, a hydrothermally synthesized BaTiO₃ powder with an average particle diameter of 130 nm was obtained.

### Production of Inner-Layer Green Sheets

Barium carbonate (BaCO₃) was added to the hydrothermally synthesized BaTiO₃ powder (average particle diameter, about 130 nm), and the resulting mixture was wet-ground for about 24 hours in water using a ZrO₂ ball mill (compounding) and then dried and subjected to heat treatment to yield a dielectric raw material. The amount of BaCO₃ added was adjusted such that the molar ratio (Ba/Ti ratio) in the ceramic dielectric constituting the inner-layer portion of the finally obtained multilayer ceramic capacitors was about 1.0025. Subsequently, a polyvinyl butyral binder and ethanol as an organic solvent were added to the resulting dielectric raw material, and wet mixing was performed for a predetermined period of time using a ball mill to produce a slurry. By shaping this slurry into sheets, inner-layer green sheets were produced.

### Production of Outer-Layer Green Sheets

BaCO₃ and ZrO₂ were to the hydrothermally synthesized BaTiO₃ powder (average particle diameter, about 130 nm), and the resulting mixture was wet-ground for about 24 hours in water using a ZrO₂ ball mill and then dried and subjected to heat treatment to yield a dielectric raw material. The amount of BaCO₃ added was adjusted such that the molar ratio (Ba/Ti ratio) in the ceramic dielectrics constituting the outer-layer portions of the finally obtained multilayer ceramic capacitors was about 1.0025. The amount of ZrO₂ added, furthermore, was set to about 0.3% by mass in relation to the BaTiO₃ powder. Subsequently, a polyvinyl butyral binder and ethanol as an organic solvent were added to the resulting dielectric raw material, and wet mixing was performed for a predetermined period of time using a ball mill to produce a slurry. By shaping this slurry into sheets, outer-layer green sheets were produced.

### Production of Side-Margin Green Bodies

BaCO₃ and ZrO₂ were added to the hydrothermally synthesized BaTiO₃ powder (average particle diameter, about 130 nm), and the resulting mixture was wet-ground for about 24 hours in water using a ZrO₂ ball mill and then dried and subjected to heat treatment to yield a dielectric raw material. The amount of BaCO₃ added was adjusted such that the molar ratio (Ba/Ti ratio) in the ceramic dielectrics constituting the side margin portions of the finally obtained multilayer ceramic capacitors was about 1.0025. The amount of ZrO₂ added, furthermore, was set to about 0.3% by mass in relation to the BaTiO₃ powder. Subsequently, a polyvinyl butyral binder and ethanol as an organic solvent were added to the resulting dielectric raw material, and wet mixing was performed for a predetermined period of time using a ball mill to produce a slurry. By shaping this slurry into sheets, side-margin green bodies were produced.

### Production of Multilayer Bodies

To the surface of the resulting inner-layer green sheets, a Ni-based conductive paste was applied by screen printing to form patterns of conductive paste layers to define and function as the inner electrode layers. After that, multiple inner-layer green sheets with the conductive paste layer formed thereon were stacked, and the outer-layer green sheets, without a conductive paste layer formed thereon, were placed on the top and bottom of the stack. By pressure-bonding the entire structure, a multilayer block was produced. Then the resulting multilayer block was cut using a dicing saw into multilayer chips. The stacking was performed such that the extended end portions of the conductive paste layers alternated. The cutting, furthermore, was performed such that the conductive paste layers were exposed on the side surfaces, and that the extended portions of the conductive paste layers were exposed on the end surfaces.

To both side surfaces of the cut multilayer chips, on which the conductive paste layers were exposed, the side-margin green bodies were attached to produce green body portions.

The resulting green body portions were subjected to heat treatment in a Ne gas stream under the conditions of a maximum temperature of about 270° C., and then subjected to heat treatment in a N₂—H₂O—H₂ gas stream under the conditions of a maximum temperature of about 800° C. After that, the green body portions were fired in a N₂—H₂O—H₂ gas stream. The firing was performed under the conditions of a maximum temperature of about 1230° C. to about 1400° C., a temperature elevation rate of about 20/second to about 60/second, a retention time of about 60 minutes, and a partial pressure of oxygen of about 5.0×10⁻¹³ to about 1.7×10⁻¹² MPa. Subsequently, heat treatment was applied in a N₂—H₂O—H₂ gas stream under the conditions of a maximum temperature of about 1050° C. x about 60 minutes. Through this, body portions were obtained.

To the end surfaces of the body portions obtained through firing, to which the inner electrode layers had been extended, a conductive paste including copper (Cu) as its primary component was applied. After that, the applied conductive paste was baked at about 900° C. to form the base layer of the outer electrodes. On the surface layer of the base layer, furthermore, Ni plating and Sn plating were performed in this order by wet plating. In such a manner, multilayer ceramic capacitors were produced.

The produced multilayer ceramic capacitors had a length L dimension of about 1.0 mm, a dimension in the width direction w of about 0.5 mm, and a dimension in the thickness direction T of about 0.5 mm. In the inner-layer portion, furthermore, the thickness of the dielectric layers was about 0.48 μm, the thickness of the inner electrode layers was about 0.38 μm, and the number of dielectric layers was 510.

### Example 2

In Example 2 of an example embodiment of the present invention, a hydrothermally synthesized BaTiO₃ powder (average particle diameter, about 80 nm) was used instead of the hydrothermally synthesized BaTiO₃ powder (average particle diameter, about 130 nm) during the production of the inner-layer green sheets. Except for this, multilayer ceramic capacitors were produced in the same or substantially the same manner as in Example 1. It should be noted that the hydrothermally synthesized BaTiO₃ powder (average particle diameter, about 80 nm) was synthesized through the same or substantially the same procedure as the hydrothermally synthesized BaTiO₃ powder (average particle diameter, about 130 nm), except that the slurry temperature during the hydrothermal was lowered.

### Example 3

In Example 3 of an example embodiment of the present invention, during the production of the outer-layer ceramic green sheets and the side-margin green bodies, ZrO₂ was not added. The amount of BaCO₃ added, furthermore, was adjusted such that the molar ratios (Ba/Ti ratios) in the outer-layer ceramics and the side-margin ceramics were about 1.0000. Except for these, multilayer ceramic capacitors were produced in the same or substantially the same manner as in Example 1.

Example 4

In Example 4 of an example embodiment of the present invention, the amount of ZrO₂ added during the production of the outer-layer ceramic green sheets and the side-margin green bodies was changed from about 0.3% by mass to about 0.5% by mass. Except for this, multilayer ceramic capacitors were produced in the same or substantially the same manner as in Example 1.

### Example 5

In Example 5 of an example embodiment of the present invention, the duration of grinding during the production of the outer-layer ceramic green sheets and the side-margin green bodies was changed from about 24 hours to about 48 hours, with no ZrO₂ added. Except for this, multilayer ceramic capacitors were produced in the same or substantially the same manner as in Example 1.

Example 6

In Example 6 of an example embodiment of the present invention, the duration of grinding during the production of the side-margin green bodies was changed from about 24 hours to about 48 hours, with no ZrO₂ added. Except for this, multilayer ceramic capacitors were produced in the same or substantially the same manner as in Example 1.

### Example 7

In Example 7 of an example embodiment of the present invention, the duration of grinding during the production of the outer-layer ceramic green sheets was changed from about 24 hours to about 48 hours, with no ZrO₂ added. Except for this, multilayer ceramic capacitors were produced in the same or substantially the same manner as in Example 1.

### Example 8

In Example 8 of an example embodiment of the present invention, during the production of the inner-layer ceramic green sheets, ZrO₂ was added together with BaCO₃, and its amount added (the amount of ZrO₂ added) was set to of an example embodiment of the present invention 0.1% by mass in relation to the BaTiO₃ powder. Except for this, multilayer ceramic capacitors were produced in the same or substantially the same manner as in Example 1.

### Example 9

In Example 9 of an example embodiment of the present invention, a mixed powder including the hydrothermally synthesized BaTiO₃ powder (average particle diameter, about 130 nm): about 70% by mass and a BaTiO₃ powder obtained by solid-phase synthesis (average particle diameter, about 130 nm): about 30% by mass was used as the primary component powder during the production of the outer-layer ceramic green sheets. The amount of BaCO₃ added during the production of the outer-layer ceramic green sheets and the side-margin green bodies, furthermore, was adjusted such that the molar ratios (Ba/Ti ratios) in the outer-layer ceramics and the side-margin ceramics were about 1.0050. Except for these, multilayer ceramic capacitors were produced in the same or substantially the same manner as in Example 1.

### Example 10

In Example 10 of an example embodiment of the present invention, a mixed powder including the hydrothermally synthesized BaTiO₃ powder (average particle diameter, about 130 nm): about 85% by mass and a BaTiO₃ powder obtained by solid-phase synthesis (average particle diameter, about 130 nm): about 15% by mass was used as the primary component powder during the production of the outer-layer ceramic green sheets. During the production of the outer-layer ceramic green sheets and the side-margin green bodies, furthermore, ZrO₂ was not added. Moreover, the amount of BaCO₃ added was adjusted such that the molar ratios (Ba/Ti ratios) in the outer-layer ceramics and the side-margin ceramics were about 1.0050. Except for these, multilayer ceramic capacitors were produced in the same or substantially the same manner as in Example 1.

### Example 11

In Example 11 of an example embodiment of the present invention, during the production of the inner-layer ceramic green sheets, ZrO₂ was added together with BaCO₃, and its amount added (the amount of ZrO₂ added) was set to about 0.1% by mass in relation to the BaTiO₃ powder. During the production of the outer-layer ceramic green sheets and the side-margin green bodies, furthermore, ZrO₂ was not added. Moreover, the amount of BaCO₃ added was adjusted such that the molar ratio (Ba/Ti ratio) in the outer-layer ceramics was about 1.0000, and that the molar ratio (Ba/Ti ratio) in the side-margin ceramics was about 1.0050. Except for these, multilayer ceramic capacitors were produced in the same or substantially the same manner as in Example 1.

### Comparative Example 1

In Comparative Example 1, a mixed powder including the hydrothermally synthesized BaTiO₃ powder (average particle diameter, about 130 nm): about 10% by mass and a BaTiO₃ powder obtained by solid-phase synthesis (average particle diameter, about 130 nm): about 90% by mass was used as the primary component powder during the production of the inner-layer ceramic green sheets. The duration of grinding during the production of the outer-layer ceramic green sheets and the side-margin green bodies, furthermore, was changed from about 24 hours to about 12 hours, with no ZrO₂ added. Except for these, multilayer ceramic capacitors were produced in the same or substantially the same manner as in Example 1.

### Comparative Example 2

In Comparative Example 2, the duration of grinding during the production of the outer-layer ceramic green sheets and the side-margin green bodies was changed from about 24 hours to about 12 hours, with no ZrO₂ added. Except for this, multilayer ceramic capacitors were produced in the same or substantially the same manner as in Example 1.

### Comparative Example 3

In Comparative Example 3, the duration of grinding during the production of the outer-layer ceramic green sheets was changed from about 24 hours to about 12 hours, with no ZrO₂ added. Except for this, multilayer ceramic capacitors were produced in the same or substantially the same manner as in Example 1.

### Comparative Example 4

In Comparative Example 4, the duration of grinding during the production of the side-margin green bodies was changed from about 24 hours to about 12 hours, with no ZrO₂ added. Except for this, multilayer ceramic capacitors were produced in the same or substantially the same manner as in Example 1.

### (2) Evaluations

For the multilayer ceramic capacitors produced in Examples 1 to 11 and Comparative Examples 1 to 4, the evaluation of characteristics was performed as follows.

### TEM Observation

Using a transmission electron microscope (TEM), a WT plane of the multilayer ceramic capacitor was observed to examine intragranular void densities. Specifically, a WT plane of the multilayer ceramic capacitor was exposed by polishing the capacitor to the middle in the length direction, and the capacitor was further processed to prepare an 80-nm thick TEM observation sample including the WT plane. Then a TEM observation of the resulting sample was performed. In this process, the cross-section was divided into the inner-layer portion, the outer-layer portions, and the side margin portions, and observation was performed for each of a portion of the ceramic dielectric in the vicinity of the middle in the W direction and the T direction in the inner-layer portion, the vicinity of the middle in the W direction and the T direction in an outer-layer portion, and the vicinity of the middle in the W direction and the T direction in a side margin portion. Then the number of voids present in dielectric particles was counted, and the number of voids per unit area (about 1 μm²) was calculated by dividing the obtained number by the area of the ceramic portion. For each of the inner-layer portion, the outer-layer portions, and the side margin portions, the same operation was performed at three points (n=3), and the average number of intragranular voids per unit area was determined as the intragranular void density.

### SEM Observation

Using a scanning electron microscope (SEM), a WT plane of the multilayer ceramic capacitor was observed to examine the thickness of the dielectric layers and diameters (D50) of dielectric particles. Specifically, a cross-section (WT plane) of the multilayer ceramic capacitor was exposed by polishing the capacitor to the middle in the length (L) direction. Then, on the exposed cross-section, a midline in the width direction W was drawn, along with two lines on each side at regular intervals from this midline in the width direction W. The thickness of a dielectric layer in the inner-layer portion located in the vicinity of the middle in the thickness direction was measured on these five lines in total, and the average was reported as the thickness of the dielectric layers.

In addition, an SEM image of dielectric particles in dielectric layers in the exposed cross-section was captured under the conditions of a magnification of about 5000×, an acceleration voltage of about 15 kV, and a field of view of about 30 μm× about 30 μm. In this process, the imaging was performed for portions of dielectric layers in the vicinity of the middle in the W direction and the T direction in the inner-layer portion. Then, using image processing software, the edges of all dielectric particles were recognized, and the cross-sectional areas of the particles were calculated. From these areas, equivalent circular diameters were calculated as the diameters of the particles. Excluding dielectric particles that were only partially imaged, the diameters of all dielectric particles included within the captured area were measured. Their average was determined, through which the average diameter of dielectric particles in the inner-layer ceramic (D50ᵢₙₙₑᵣ) was determined. In addition, imaging was performed for the vicinity of the middle in the W direction and the T direction in an outer-layer portion and the vicinity of the middle in the W direction and the T direction in a side margin portion, and the average diameter of dielectric particles in the outer-layer ceramics (D50ₒᵤₜₑᵣ) and the average diameter of dielectric particles in the side-margin ceramics (D50_{side}) were determined.

### Humidity Load Test

For 100 samples, a humidity load test was performed under the conditions of about 85° C.-relative humidity of about 85%-6.3 V. After about 250 hours, about 500 hours, or about 1000 hours passed, the samples were removed from the test chamber, and the insulation resistance (IR) when a voltage of about 6.3 V was applied for about 60 seconds at room temperature was measured. With LogIR>about 4 being the criterion, the test was considered passed (o) if all 100 samples satisfied the criterion and failed (x) if there was one or more samples for which LogIR≤about 4. Based on the results of the moisture resistance test obtained, furthermore, an assessment was made according to the following criteria.
⊚: The samples passed the test at about 1000 hours
○: The samples passed the test at about 250 hours, but failed at about 500 hours or about 1000 hours
×: The samples failed the test at about 250 hours

### (3) Evaluation Results

The evaluation results obtained for the multilayer ceramic capacitors in Examples 1 to 11 and Comparative Examples 1 to 4 are summarized in Table 1.

In Examples 1 to 11, both of the intragranular void densities in the outer-layer portions and the side margin portions (Nₒᵤₜₑᵣ and N_{side}) were smaller than the intragranular void density in the inner-layer portion (Nᵢₙₙₑᵣ). As a result, the results of the humidity load test were good, with the samples passing the test at about 250 hours. In particular, in Examples 1, 2, and 4 to 8, the results of the humidity load test were excellent, with the samples passing the test even at about 1000 hours.

Incidentally, in Examples 1 to 11, the results of the humidity load test vary. This is because the number of intragranular voids has a great impact on moisture resistance, but second to it, the solubility of the components of grain boundaries in water also influences moisture resistance. When the components of grain boundaries are highly soluble, moisture resistance decreases. For example, when the molar ratio (Ba/Ti) is increased, the amount of Ba in the ceramic becomes greater, and the Ba concentration at grain boundaries becomes higher. When the Ba concentration at grain boundaries is high, the dissolution of the components of the grain boundaries in water is more likely to occur. Moisture resistance, therefore, decreases. When the amount of Zr in a ceramic is large, furthermore, the Zr concentration at grain boundaries is high. Zr at grain boundaries limits the dissolution of the components of the grain boundaries. Conversely, when the amount of Zr is small, the Zr concentration at grain boundaries is low, and the dissolution of the components of the grain boundaries can no longer be limited. As a result, the moisture resistance period shortens.

Among Examples 1 to 11, therefore, in Example 9, in which the molar ratio was relatively high, moisture resistance was relatively low, with the result of the humidity load test being “o.” In addition, in Examples 3 and 11, in which the amount of Zr was relatively small, moisture resistance was also relatively low, with the result of the humidity load test being “o.” In Example 10, the result of the humidity load test was “o,” but the molar ratio was high, and the amount of Zr was small. As a result, the samples passed the test at about 250 hours but failed at about 500 hours.

In Comparative Examples 1 to 4, one or both of the proportions of intragranular voids in the outer-layer portions and the side margin portions (Nₒᵤₜₑᵣ and N_{side}) were greater than the proportion of intragranular voids in the inner-layer portion (Nᵢₙₙₑᵣ). As a result, the results of the humidity load test were poor, with the samples failing the test at about 250 hours.

TABLE 1
Characteristics of the Multilayer Ceramic Capacitors

| | Intragranular void | | | | | | | | | | | | |
|---|---|---|---|---|---|---|---|---|---|---|---|---|---|
| | density (voids/μm²) | | | | | | | | | | | | |
| | (average of fields of | | | | | | | | | | | | |
| | view, n = 3, in a 2-μm | | | Zr concentration | | | D50 of dielectric | | | Results of | | | |
| | square area) | | | (mass %) | | | particles (nm) | | | the humidity | | | |
| | Inner- | Outer- | | Inner- | Outer- | | Inner- | Outer- | | load test | | | |
| | layer | layer | Side | layer | layer | Side | layer | layer | Side | 250 | 500 | 1000 | Over |
| | portion | portions | portions | portion | portions | portions | portion | portions | portions | h | h | h | all |
| Example 1 | 11 | 7 | 7 | 0.10 | 0.40 | 0.40 | 183 | 230 | 250 | ◯ | ◯ | ◯ | ⊚ |
| Example 2 | 23 | 13 | 13 | 0.10 | 0.40 | 0.40 | 130 | 230 | 250 | ◯ | ◯ | ◯ | ⊚ |
| Example 3 | 11 | 7 | 7 | 0.10 | 0.10 | 0.10 | 168 | 230 | 250 | ◯ | ◯ | X | ◯ |
| Example 4 | 11 | 3 | 3 | 0.10 | 0.60 | 0.60 | 180 | 420 | 450 | ◯ | ◯ | ◯ | ⊚ |
| Example 5 | 12 | 11 | 11 | 0.10 | 0.15 | 0.16 | 180 | 200 | 210 | ◯ | ◯ | ◯ | ⊚ |
| Example 6 | 12 | 6 | 11 | 0.10 | 0.45 | 0.15 | 180 | 210 | 250 | ◯ | ◯ | ◯ | ⊚ |
| Example 7 | 12 | 11 | 6 | 0.10 | 0.15 | 0.48 | 180 | 230 | 250 | ◯ | ◯ | ◯ | ⊚ |
| Example 8 | 8 | 6 | 6 | 0.20 | 0.42 | 0.41 | 210 | 250 | 260 | ◯ | ◯ | ◯ | ⊚ |
| Example 9 | 11 | 8 | 8 | 0.10 | 0.40 | 0.40 | 180 | 130 | 130 | ◯ | ◯ | X | ◯ |
| Example 10 | 11 | 10 | 10 | 0.10 | 0.10 | 0.10 | 180 | 130 | 130 | ◯ | X | X | ◯ |
| Example 11 | 11 | 7 | 7 | 0.20 | 0.10 | 0.10 | 183 | 230 | 250 | ◯ | ◯ | X | ◯ |
| Comparative | 1 | 13 | 13 | 0.10 | 0.05 | 0.05 | 183 | 180 | 185 | X | X | X | X |
| Example 1 | | | | | | | | | | | | | |
| Comparative | 11 | 13 | 13 | 0.10 | 0.05 | 0.05 | 183 | 180 | 185 | X | X | X | X |
| Example 2 | | | | | | | | | | | | | |
| Comparative | 11 | 13 | 6 | 0.10 | 0.05 | 0.40 | 183 | 185 | 250 | X | X | X | X |
| Example 3 | | | | | | | | | | | | | |
| Comparative | 11 | 5 | 13 | 0.10 | 0.40 | 0.05 | 183 | 230 | 180 | X | X | X | X |
| Example 4 | | | | | | | | | | | | | |

From these results, it is to be understood that according to example embodiments of the present invention, multilayer ceramic capacitors each with superior moisture resistance are provided.

Example embodiments of the present invention have been described above. The present invention, however, is not limited to the example embodiments, and it can be modified without departing from the gist and scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
an inner-layer portion including at least one first inner electrode layer and at least one second inner electrode layer alternately stacked with at least one dielectric layer including a ceramic dielectric interposed therebetween, a first primary surface facing a stacking direction, a second primary surface opposite to the first primary surface, a first side surface facing a width direction, orthogonal or substantially orthogonal to the first primary surface and the second primary surface, and to which the first inner electrode layer and the second inner electrode layer are extended, a second side surface opposite to the first side surface and to which the first inner electrode layer and the second inner electrode layer are extended, a first end surface facing a length direction orthogonal or substantially orthogonal to the first primary surface, the second primary surface, the first side surface, and the second side surface, and to which the first inner electrode layer is extended, and a second end surface opposite to the first end surface and to which the second inner electrode layer is extended;
a first outer-layer portion including a ceramic dielectric and covering the first primary surface in the stacking direction;
a second outer-layer portion including a ceramic dielectric and covering the second primary surface in the stacking direction;
a first side margin portion including a ceramic dielectric and covering the inner-layer portion, the first outer-layer portion, and the second outer-layer portion from one side in the width direction;
a second side margin portion including a ceramic dielectric and covering the inner-layer portion, the first outer-layer portion, and the second outer-layer portion from another side in the width direction; and
a pair of outer electrodes on the first end surface and the second end surface and coupled to each of the first inner electrode layer and the second inner electrode layer; wherein
each of the ceramic dielectrics of the inner-layer portion, the first outer-layer portion, the second outer-layer portion, the first side margin portion, and the second side margin portion includes a plurality of dielectric particles including a void therein; and
an intragranular void density in the ceramic dielectric in the inner-layer portion (Nᵢₙₙₑᵣ), intragranular void densities in the ceramic dielectrics in the first outer-layer portion and the second outer-layer portion (Nₒᵤₜₑᵣ), and intragranular void densities in the ceramic dielectrics in the first side margin portion and the second side margin portion (N_{side}) satisfy Nₒᵤₜₑᵣ<Nᵢₙₙₑᵣ and N_{side}<Nᵢₙₙₑᵣ.

2. The multilayer ceramic capacitor according to claim 1, wherein a Zr concentration in the ceramic dielectric in the inner-layer portion (Zrᵢₙₙₑᵣ), Zr concentrations in the ceramic dielectrics in the first outer-layer portion and the second outer-layer portion (Zrₒᵤₜₑᵣ), and Zr concentrations in the ceramic dielectrics in the first side margin portion and the second side margin portion (Zr_{side}) satisfy Zrᵢₙₙₑᵣ<Zrₒᵤₜₑᵣ and Zrᵢₙₙₑᵣ<Zr_{side}.

3. The multilayer ceramic capacitor according to claim 1, wherein an average diameter of dielectric particles in the ceramic dielectric in the inner-layer portion (D50ᵢₙₙₑᵣ), average diameters of dielectric particles in the ceramic dielectrics in the first outer-layer portion and the second outer-layer portion (D50ₒᵤₜₑᵣ), and average diameters of dielectric particles in the ceramics in the first side margin portion and the second side margin portion (D50_{side}) satisfy D50ᵢₙₙₑᵣ<D50ₒᵤₜₑᵣ and D50ᵢₙₙₑᵣ<D50_{side}.

4. The multilayer ceramic capacitor according to claim 3, wherein the D50ᵢₙₙₑᵣ is about 130 nm or more and about 210 nm or less.

5. The multilayer ceramic capacitor according to claim 1, wherein the Nᵢₙₙₑᵣ, the Nₒᵤₜₑᵣ, and the N_{side} satisfy Nₒᵤₜₑᵣ<N_{side}<Nᵢₙₙₑᵣ.

6. The multilayer ceramic capacitor according to claim 1, wherein the Nᵢₙₙₑᵣ, the Nₒᵤₜₑᵣ, and the N_{side} satisfy N_{side}<Nₒᵤₜₑᵣ<Nᵢₙₙₑᵣ.

7. The multilayer ceramic capacitor according to claim 1, wherein
a dimension of the multilayer ceramic capacitor in the length direction is about 0.2 mm or more and about 3.2 mm or less;
a dimension of the multilayer ceramic capacitor in the width direction is about 0.1 mm or more and about 2.5 mm or less; and
a dimension of the multilayer ceramic capacitor in the stacking direction is about 0.1 mm or more and about 2.5 mm or less.

8. The multilayer ceramic capacitor according to claim 1, wherein each of the plurality of dielectric particles includes a perovskite oxide as a main component.

9. The multilayer ceramic capacitor according to claim 8, wherein the perovskite oxide includes at least one of a barium titanate compound, a calcium titanate compound, or a strontium titanate compound.

10. The multilayer ceramic capacitor according to claim 8, wherein each of the plurality of dielectric particles includes at least one of a rare earth element, magnesium, manganese, iron, chromium, cobalt, nickel, silicon, aluminum, or vanadium as a secondary component.

11. The multilayer ceramic capacitor according to claim 1, wherein the plurality of dielectric particles include core-shell particles.

12. The multilayer ceramic capacitor according to claim 1, wherein a thickness of the at least one dielectric layer is about 0.3 μm or more and about 0.5 μm or less.

13. The multilayer ceramic capacitor according to claim 1, wherein each of the at least one first inner electrode layer and the at least one second inner electrode layer includes nickel, copper, silver, palladium, a silver-palladium alloy, or gold.

14. The multilayer ceramic capacitor according to claim 1, wherein a thickness of each of the at least one first inner electrode layer and the at least one second inner electrode layer is about 0.30 μm or more and about 0.40 μm or less.

15. The multilayer ceramic capacitor according to claim 1, wherein each of the first and second outer-layer portions and the first and second side margin portions includes no inner electrode layer.

16. The multilayer ceramic capacitor according to claim 1, wherein the intragranular void density in the inner-layer ceramic Nᵢₙₙₑᵣ is about 8 voids/μm² or more and about 23 voids/μm² or less.

17. The multilayer ceramic capacitor according to claim 1, wherein the intragranular void density in the inner-layer ceramic Nᵢₙₙₑᵣ is about 11 voids/μm² or more and about 23 voids/μm² or less.

18. The multilayer ceramic capacitor according to claim 1, wherein an average diameter of each of the voids is about 10 nm or more and about 50 nm or less.

19. The multilayer ceramic capacitor according to claim 1, wherein an average diameter of each of the voids is about 10 nm or more and about 30 nm or less.

20. The multilayer ceramic capacitor according to claim 1, wherein an intragranular void density of the outer-layer ceramics Nₒᵤₜₑᵣ and the side-margin ceramics is about 3 voids/μm² or more and about 13 voids/μm² or less.
